(19) United States
(12) Patent Application Publication
(10) Pub. No.: US 2019/0264793 A1
(43) Pub. Date: Aug. 29, 2019

(54) Gear Pair Comprising a Gear with a Surface Structure, Transmission Comprising Gear Pair, and Method for Producing a Gear

(71) Applicant: Bayerische Motoren Werke Aktiengesellschaft, Muenchen (DE)

(72) Inventors: Tobias HERTTER, Muenchen (DE); Hakan SAHIN, Muenchen (DE)

(21) Appl. No.: 16/411,681

(22) Filed: May 14, 2019

Related U.S. Application Data
(63) Continuation of application No. PCT/EP2017/078386, filed on Nov. 7, 2017.

(30) Foreign Application Priority Data
Nov. 22, 2016 (DE) 10 2016 223 058.1

(51) Int. Cl. F16H 55/06; F16H 1/10; F16H 1/14; F16H 55/17; B24C 1/04; B23F 19/00

(52) U.S. Cl. CPC F16H 55/06; F16H 1/10; F16H 1/14; F16H 2055/176; B24C 1/04; B23F 19/00; F16H 55/17

(57) ABSTRACT

A gear pair including at least one first gear with a microstructure and at least one additional gear is provided. The first gear has first teeth with first tooth flanks and the additional gear has additional teeth with additional tooth flanks. In order to transfer power from the first gear to the additional gear, a first tooth flank contacts an additional tooth flank on an imaginary tangential plane which touches both tooth flanks in a contact point. The addition of the speeds of the two tooth flanks in the contact point on the tangential plane produces a sum speed. The microstructure is designed as a depression on the first tooth flank and runs at least partly along a structure line on the first tooth flank, and the structure line is touched by a structure tangent in the contact point. The structure tangent lies on the tangential plane.

### CROSS REFERENCE TO RELATED APPLICATIONS

This application is a continuation of PCT International Application No. PCT/EP2017/078386, filed Nov. 7, 2017, which claims priority under 35 U.S.C. § 119 from German Patent Application No. 10 2016 223 058.1, filed Nov. 22, 2016, the entire disclosures of which are herein expressly incorporated by reference.

### BACKGROUND AND SUMMARY OF THE INVENTION

The present invention relates to a gearwheel pair including a gearwheel with a multiplicity of teeth, each tooth having at least one tooth flank with a microstructure for the transmission of power, and to a gear mechanism including a gearwheel pair of this type, and to a method for producing it. A gearwheel pair including a gearwheel is known from DE 10 2010 038 438 A1.

Gearwheels serve for the transmission of rotational movements and torques (transmission of power) from a drive shaft to an output shaft. It is possible for said gearwheels to be configured, for example, as spur gears, bevel gears, hypoid gears, crown gears, helical gears or worm gears.

A special design of bevel gear mechanisms is the hypoid toothing system (bevel gear mechanism with a positive axial offset) which allows the drive axis and the output axis to be oriented at an angle with respect to one another, the axes additionally being offset with respect to one another. Hypoid toothing systems are used in automotive engineering, generally in the case of axle drives. Owing to the axial offset, sliding of the tooth flanks longitudinally on one another occurs during operation, which leads to a power loss and therefore to a reduction of the degree of efficiency of the gear mechanism. The invention can preferably be applied to gearwheels which have a “high” proportion of sliding motion, since gearwheels of this type have an increased power loss, in particular, in comparison with gearwheels with a “low” proportion of sliding motion.

The invention can preferably be applied to hypoid toothing systems, since they have a higher proportion of sliding motion during the transmission of power than bevel gear toothing systems without an axial offset. The invention can further preferably be applied to helically toothed spur gears and internal gears, since they have a higher proportion of sliding motion during the transmission of power than corresponding spur toothed gear wheels.

In the case of a bevel gear mechanism with a predefined axial offset, the frictional losses which are caused by way of the sliding, in particular the longitudinal sliding, can be minimized by way of a reduction of the coefficients of friction of the individual tooth flanks. In a first approximation, the entire tooth flank (active tooth flank) which participates in the engagement of the teeth of a gearwheel pair is taken into consideration, and the coefficient of friction is assumed to be constant. Based on this, customary measures are taken, such as improved lubricants, in particular improved base oils or improved additives, optimized tooth flank surface topology or coating of the tooth flank, in order to reduce the friction.

The coefficient of friction is a function of the locally prevailing states, such as the local pressure and the local sliding speed. Furthermore, the direction of the sliding speed, of the contact path and of the contact lines also influences the local coefficient of friction decisively.

It is an object of the present invention to specify a gearwheel pairing including a gearwheel with a microstructure, a gear mechanism including a gearwheel pair of this type, and a method for producing a gearwheel of this type, a gearwheel pair of this type having an improved degree of efficiency during the transmission of power in comparison with a conventional gearwheel pair.

A gearwheel pair having a gearwheel, a gear mechanism, and a method for production in accordance with embodiments are proposed to achieve said object.

The invention relates to a gearwheel pair having at least one, preferably having two, first gearwheel/gearwheels, a first gearwheel of this type having a microstructure. A gearwheel pair of this type preferably has a further gearwheel which preferably does not have any microstructure in accordance with the first gearwheel, or with preference is identical to said first gearwheel, in relation to the microstructure on the tooth flank. The first gearwheel preferably has first teeth with first tooth flanks, and the first gearwheel has further teeth with further tooth flanks.

It is provided, in particular for the transmission of power from the first gearwheel to the further gearwheel, that at least one of the first tooth flanks makes contact with at least one of the further tooth flanks in an imaginary tangential plane.

In particular, the tangential plane makes contact with said two tooth flanks at a contact point. Said contact point is to be understood, in particular, to be an individual point of a contact line, since tooth flanks of gearwheels frequently do not make contact merely at one contact point, but rather along a contact line which runs over a tooth width during the transmission of power. During the transmission of power, said contact line as a rule migrates from the first gearwheel to the further gearwheel via the tooth flank, in particular in a tooth height direction.

At said contact point, the first tooth flank and the further tooth flank in each case have a speed which is dependent on the geometry of the gearwheel. That part of said speed which lies in the imaginary tangential plane can generally be understood to be a tangential speed, and is well known (Niemann, Winter; Maschinenelemente Band II [Niemann, Winter; Machine Elements, Volume II]; page 38; chapter 21.1.7 Sliding and rolling movement of the tooth flanks).

Within the context of this invention, what is known as the total speed is to be understood to mean the sum of the tangential speeds at the contact point of the tooth flanks. In particular, the direction of said total speed is of importance for the invention. Said total speed, and/or the direction of said total speed, preferably results, in particular, from a vectorial addition of the tangential speeds of the tooth flanks at the contact point.

Within the context of the invention, a microstructure is to be understood to mean a depression on one of the first tooth flanks. Said microstructure is preferably arranged on a multiplicity of first tooth flanks and preferably on all first tooth flanks. A multiplicity of said microstructures is preferably provided on the first tooth flank or flanks. A microstructure of this type is configured, in particular, as a recess or clearance on the relevant tooth flank.

A microstructure of this type is further preferably configured by way of a material elevation, and further preferably by way of an addition of material, the material elevation or the addition of material preferably being lower in the region of the recess than in regions which are adjacent with respect to the recess.

Said microstructure is preferably to be understood to be a groove-like recess or clearance which preferably extends on the tooth flank in a transverse direction, or extends with preference substantially in a tooth width direction. Further preferably, therefore, the microstructure extends with particular preference along a structuring line at least in sections or preferably completely.

The structuring line is to be understood, in particular, to be a geometric, simple description of the longitudinal extent of the microstructure. The structuring line is preferably an averaged course of the microstructure. Furthermore, a cross-sectional profile of the microstructure describes, in particular, the form of the recess or clearance, and, in particular, the structuring line describes the location and the course of the microstructure on the tooth flank, at least approximately.

The microstructure lies in a microscopic range, in particular in comparison with main dimensions of a first tooth of the first gearwheel. Whereas said main dimension, in particular a tooth height, lies in the range of a few or more millimeters, a depth of the recess of the microstructure lies in the range of a few micrometers.

A structuring tangent is to be understood, in particular, to be a tangent to the structuring line in the tangential plane at the contact point.

A multiplicity of microstructures of this type are preferably to be regarded to be an irregular structure which is oriented transversely with respect to a sliding direction on the first tooth flank or flanks, in relation to the transmission of power from the first gearwheel to the further gearwheel. Said microstructures are further preferably arranged in the region of the hard or tribochemical layer, in relation to a depth or an extent of depth. Here, a “hard” layer relates to customary gearwheels which are known from the prior art as surface-hardened components, in particular case-hardened, induction-hardened or nitrided gearwheels. Therefore, the microstructure does not extend, in particular, through said hard layer, but rather merely into it.

The depth of the microstructure preferably lies in a range which is greater than 0.1 μm (1 μm corresponds to 10⁻⁶ m), is preferably greater than 0.5 μm, with preference is greater than 1 μm, and particularly preferably is greater than 1.5 μm, and, furthermore, said range is less than 10 μm, preferably less than 5 μm, with preference less than 2.5 μm, and said depth is particularly preferably at least approximately 2 μm. “Approximately” is preferably to be understood to mean a deviation of ±0.5 μm.

A multiplicity of said microstructures are preferably provided in sections of the first tooth flanks which have locally high friction properties and/or coefficients of friction. Here, “high” is to be understood to mean that they are higher than an averaged coefficient of friction for the entire tooth flank. The cost-benefit relationship can be increased, in particular, by way of the application of suitable microstructures to small regions with disproportionately high coefficients of friction.

The orientation of the microstructure to the intersection of second straight lines (structure tangent, total speed, and/or direction of the total speed) in one plane (tangential plane) is ascribed, in particular, by way of the introduction of an angle y. In the case of an intersection of this type in the plane, two different angles as a rule arise, of which one is an obtuse angle and the other is an acute angle; furthermore, the special case of an orthogonal intersection is contemplated (angle of intersection 90°). The angle y is preferably the acute angle of said two angles or a right angle, and is preferably selected from a range which is less than or equal to 90°, preferably less than 85°, with preference less than 80°, and said angle is further preferably greater than 30°, preferably greater than 45° and particularly preferably greater than 60°. The angle y is very particularly preferably, at least substantially, 90°. In this context, “at least substantially” is to be understood to mean that the angle y is less than or equal to 90° and greater than 85°. Tests have shown that a particularly favorable characteristic of the degree of efficiency during the transmission of power can be achieved, in particular, by way of a structuring of this type.

In one preferred embodiment, the first gearwheel is configured as an octoidally toothed or involutely toothed bevel gear, pinion or ring gear. The gearwheel pair is preferably configured as a bevel gearwheel pair, and the first gearwheel or the further gearwheel has an axial offset, preferably a positive axial offset, and the gearwheel pair is therefore configured as what is known as a hypoid toothing system, or as a gearwheel pair with hypoid gearwheels. In particular, gearwheels of this type have a particularly high degree of efficiency in the configuration according to the invention.

In one preferred embodiment of the invention, the further gearwheel also has a microstructure, preferably a multiplicity of microstructures, in accordance with the first gearwheel. Tests have shown that the degree of efficiency can be increased further in the case of a gearwheel pair, in the case of which the two gearwheels are provided with microstructures.

In one preferred embodiment of the invention, one of said microstructures, preferably a multiplicity of said microstructures and particularly preferably all the microstructures have a depth of less than 10 μm at least in sections, on preferably one of the first tooth flanks, preferably on a multiplicity of the first tooth flanks and particularly preferably on all the first tooth flanks. Further preferably, one of said microstructures, preferably a multiplicity of said microstructures and particularly preferably all the microstructures have a depth of less than 10 μm and particularly preferably of more than 0.1 μm over their complete course. A particularly satisfactory characteristic of the degree of efficiency of the gearwheel pair during the transmission of power can be achieved, in particular, by way of the selection of the depth of the microstructure from the abovementioned range.

A transmission of a motor vehicle, preferably a motor vehicle transmission, is preferably provided, in which a gearwheel pair according to the invention is used for the transmission of power. The degree of efficiency of a transmission of this type can be increased, in particular, by way of the use of the gearwheel pair according to the invention.

Furthermore, a method for producing a gearwheel for the gearwheel pair according to the invention is provided. A production method of this type has the steps:

providing of a gearwheel;

applying of at least one of said microstructures, preferably a multiplicity of microstructures, to at least one of the tooth flanks of said gearwheel; and

said microstructure or microstructures being oriented in each case along the structuring line.

The course and the determination of the course of the structuring line are described above. The course of the structuring lines is preferably defined by way of a calculation method and preferably on a data processing system.

Further preferably, the structuring line has an undulating course, at least in sections. Further preferably, a multiplicity of microstructures are arranged on the tooth flank and, as a result in particular, the tooth flank has an undulating surface, in particular including tiny crests and troughs, it being possible for each trough to be considered to be one of said macrostructures.

In one preferred embodiment of the method, the microstructure is applied to the tooth flank by way of material erosion. The material erosion is preferably applied by way of a laser structuring method. In one further preferred embodiment, the gearwheel with the at least one microstructure is produced in a 3D printing method. Particularly rapid and precise applying of the at least one microstructure to the tooth flank is made possible, in particular, by way of said methods.

In one preferred embodiment, the at least one microstructure is produced by way of a rolling movement of a tool which rolls on the first gearwheel during the production of said gearwheel. Said rolling movement of the rolling tool is preferably superimposed by an oscillation, preferably a torsional oscillation. In particular, said oscillation is crucial for the production of the at least one microstructure on the tooth flanks. A particularly satisfactory integration of the production of the microstructure into the normal production process of the gearwheel can be achieved, in particular, by way of the production of the at least one microstructure by way of the proposed production process.

In one preferred embodiment, the at least one microstructure is produced in a running-in phase of the gearwheel pair with the use of a first lubricant with a first lubricant viscosity.

Said running-in phase can preferably take place in a production plant, preferably in a transmission housing and particularly preferably as early as during the use in a final product, in particular in the motor vehicle transmission. Figuratively speaking, in the case of a method of this type, a conventional gearwheel pair is installed into the motor vehicle transmission, and the at least one microstructure is produced during the first operating hours of the vehicle, what is known as running in.

The first lubricant viscosity is preferably selected, in relation to the kinematic viscosity at 100° C., from a range which is less than 5.0 cSt (centistokes; 10⁻⁶ mm²/s), preferably less than 4.0 cSt, and the first lubricant viscosity is particularly preferably 3.5 cSt or less.

Further preferably, the gearwheel pair according to the invention is operated after said running-in phase with a lubricant which has a second lubricant viscosity. Said second lubricant viscosity is preferably selected from a range, in relation to the kinematic viscosity at 100° C., which is greater than or equal to 4.0 cSt, is preferably greater than 5.0 cSt, and is particularly preferably greater than 6.0 cSt, and, furthermore, said range is less than 10.0 cSt, is preferably less than 9.0 cSt, and is particularly preferably less than or equal to 8.0 cSt.

Further preferably, the first lubricant is thickened by way of the addition of an additive, with the result that said first lubricant changes its lubricant viscosity, as described. Further preferably, the first lubricant has an aging behavior, with the result that, after considerable operating time, said first lubricant changes its lubricant viscosity, as described. Further preferably, a second lubricant with the second lubricant viscosity is used after the production of the microstructure. A particularly simple production of the at least one microstructure is made possible, in particular, by way of the selection of the lubricant viscosity from the abovementioned range or ranges.

The at least one microstructure is preferably applied to a gearwheel, the tooth flank of which is produced by way of a lapping operation or preferably a grinding operation.

In one preferred embodiment, the at least one microstructure is applied in the form of a hard coating. Methods for hard coating are known from the prior art per se. A particularly flexible production of the at least one microstructure is made possible, in particular, by way of a production method of this type.

In one preferred embodiment of the method, the at least one microstructure is covered with a hard coating, at least in sections or preferably completely. Here, in this context, covering is to be understood, in particular, to mean that an outer surface of the hard coating configures the at least one microstructure. In other words, the applied hard coating does not level the at least one microstructure; said structure is rather retained on the tooth flank and, in particular, a surface pattern comprising tiny crests and troughs (multiplicity of microstructures) is retained on the tooth flank, which surface pattern is active during the transmission of power in the described context. By way of the covering of the microstructure by way of a hard coating, in particular, said microstructure is particularly insensitive and is retained for a particularly long time, preferably permanently, during operation of the gearwheel pair.

In one preferred embodiment of the method, the course of the structuring line is calculated, at least in sections or completely, by way of a simulation method. Methods and computing programs for determining the total speed are known; the total speed is the basis for determining the course of the structuring line. In particular, the calculation of the course of the structuring line makes it possible to manufacture it particularly precisely and therefore to manufacture a gearwheel with improved activation.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a part of a first gearwheel.

FIG. 2 is a partial section through a first gearwheel.

FIG. 3 is a detail of the tangential plane.

### DETAILED DESCRIPTION OF THE DRAWINGS

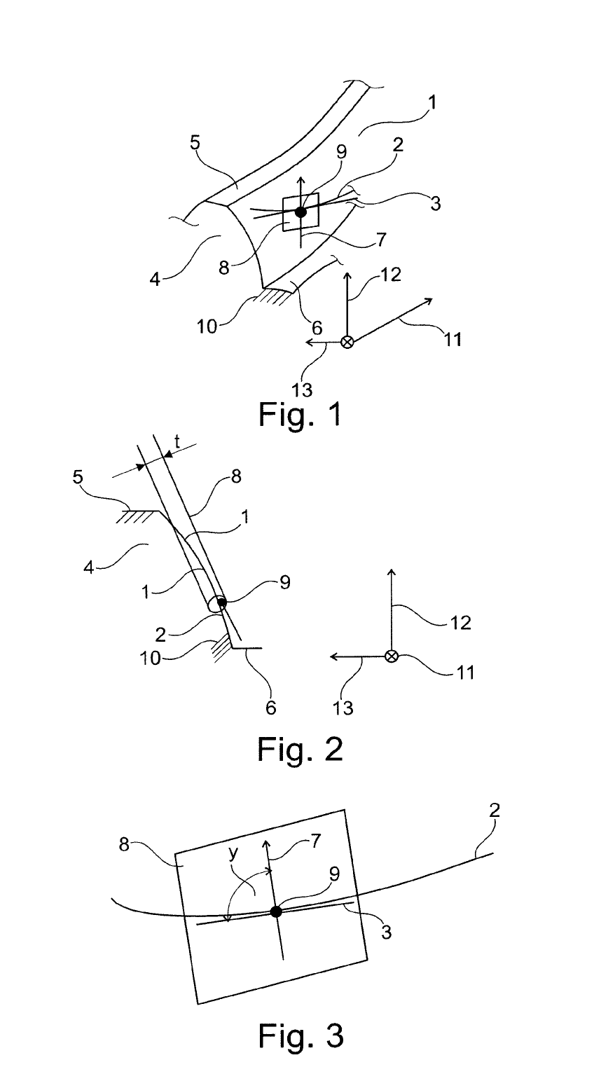

FIG. 1 shows a perspective partial section of the first gearwheel. The tooth 4 of the gearwheel extends in the longitudinal direction 11 and has a tooth height extent in the tooth height direction 12; the recess of the microstructure 2 extends substantially in the tooth depth direction 13. Said first gearwheel has a first tooth 4 with a first tooth flank 1. The microstructure 2 which is illustrated by way of the structuring line is applied on the first tooth flank 1. For the sake of clarity, only one microstructure 2 is shown; in reality, the first tooth flank 1 has a multiplicity of microstructures 2 of this type. At the contact point 9, the microstructure 2 has the course which is approximated by way of the structure tangent 3. Here, the structure tangent 3 lies in the tangential plane 8 at the contact point 9 and is tangent on both the first tooth flank 1 and the tooth flank (not shown) of the further gearwheel which makes contact with the first tooth flank at the contact point 9.

The total speed 7 prevails at the contact point 9. The first tooth 4 extends between the tooth root 6 and the tooth tip 5 in the tooth height direction. Starting from the tooth flank, the microstructure 2 extends into the material 10 of the first tooth 1 and is therefore configured as a recess on the first tooth flank 1.

FIG. 2 shows a sectional illustration through the first tooth flank 1. The tooth 4 of the gearwheel extends in the longitudinal direction 11, that is to say substantially in the direction orthogonally with respect to the plane of the illustration, and has a tooth height extent in the tooth height direction 12; the recess of the microstructure 2 extends substantially in the tooth depth direction 13. Here, the depth t of the microstructure 2 is shown greatly exaggerated, in comparison with the remaining geometry of the first tooth flank 1; this serves for improved representability.

The microstructure 2 is arranged at the contact point 9; it is once again to be noted that the tooth flank 1 in reality has a multiplicity of microstructures 2 of this type. The first tooth 4 extends between the tooth root 6 and the tooth tip 5. The microstructure 2 runs at least substantially into the plane of the illustration and therefore at least substantially in the tooth width direction. Starting from the tooth flank 1, the microstructure 2 extends into the material 10 of the first tooth 4. The tangential plane 8 is tangent on the tooth flank 1 at the contact point 9.

FIG. 3 shows a detail of the tangential plane 8. The contact point 9 lies in the tangential plane 8. At the contact point 9, the microstructure 2 can be approximated by way of the structure tangent 3. Furthermore, the total speed 7 lies at the contact point 9 in the tangential plane 8. The direction of the total speed 7 and the structure tangent 3 enclose the acute angle y. A particularly favorable characteristic of the degree of efficiency can be achieved by way of the microstructure 2 for the gearwheel pair according to the invention, in particular, by way of the orientation of the microstructure 2 transversely with respect to the total speed 7 at the respective contact point 9.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A gearwheel pair comprising:
at least a first gearwheel with a microstructure; and
a further gearwheel, wherein
the first gearwheel includes first teeth with first tooth flanks,
the further gearwheel includes further teeth with further tooth flanks, where a first tooth flank makes contact with a further tooth flank in an imaginary tangential plane which is tangent on the two tooth flanks at a contact point for transmission of power from the first gearwheel to the further gearwheel,
addition of speeds of the two tooth flanks at the contact point results in a total speed in the tangential plane,
the microstructure is configured as a depression on the first tooth flank and runs at least in sections along a structuring line on the first tooth flank,
a structure tangent which lies in the tangential plane is tangent on the structuring line at the contact point, and
the structure tangent and the total speed enclose an angle y, and the angle y is selected from a range which is greater than 25° and less than or equal to 90°.

2. The gearwheel pair according to claim 1, wherein the first gearwheel is configured as an octoidally or involutely toothed bevel gear, pinion and/or ring gear.

3. The gearwheel pair according to claim 1, wherein the further gearwheel also has a microstructure in accordance with the first gearwheel.

4. The gearwheel pair according to claim 1, wherein the microstructure has a depth of less than 10 μm at least in sections and of more than 0.1 μm at least in sections.

5. The gearwheel pair according to claim 3, wherein the microstructure has a depth of less than 10 μm at least in sections and of more than 0.1 μm at least in sections.

6. The gearwheel pair according to claim 1, wherein, over its complete course, the microstructure has a depth of less than 10 μm and of more than 0.1 μm.

7. The gearwheel pair according to claim 3, wherein, over its complete course, the microstructure has a depth of less than 10 μm and of more than 0.1 μm.

8. The gearwheel pair according to claim 1, wherein a multiplicity of said microstructures are arranged on at least one of the first tooth flanks.

9. The gearwheel pair according to claim 7, wherein a multiplicity of said microstructures are arranged on at least one of the first tooth flanks.

10. A gear mechanism of a motor vehicle comprising:
a gearwheel pair according to claim 1.

11. A method for producing a gearwheel for a gearwheel pair comprising:
at least a first gearwheel with a microstructure; and
a further gearwheel, wherein
the first gearwheel includes first teeth with first tooth flanks,
the further gearwheel includes further teeth with further tooth flanks, where a first tooth flank makes contact with a further tooth flank in an imaginary tangential plane which is tangent on the two tooth flanks at a contact point for transmission of power from the first gearwheel to the further gearwheel,
addition of speeds of the two tooth flanks at the contact point results in a total speed in the tangential plane,
the microstructure is configured as a depression on the first tooth flank and runs at least in sections along a structuring line on the first tooth flank,
a structure tangent which lies in the tangential plane is tangent on the structuring line at the contact point, and
the structure tangent and the total speed enclose an angle y, and the angle y is selected from a range which is greater than 25° and less than or equal to 90°, the method comprising the acts of:
providing a gearwheel; and
applying at least one microstructure, wherein the microstructure or the microstructures runs/run along the structuring line.

12. The method according to claim 11, wherein the microstructures are applied by way of material erosion.

13. The method according to claim 11, wherein
the microstructures are produced by way of a rolling movement of a tool which rolls on the first gearwheel, and
the rolling movement is superimposed by an oscillation.

14. The method according to claim 11, wherein
the microstructures are produced in a running-in phase with the use of a first lubricant with a first lubricant viscosity, and
in relation to kinematic viscosity at 100° C., the first lubricant viscosity is selected from a range which is smaller than 5.0 cSt.

15. The method according to claim 11, wherein the microstructures are applied in the form of a hard coating.

16. The method according to claim 11, wherein the microstructures are covered at least in sections or completely by way of a hard coating.

17. The method according to claim 14, wherein the microstructures are covered at least in sections or completely by way of a hard coating.

18. The method according to claim 11, wherein a course of the structuring line is at least in sections or completely by way of a simulation method on a data processing system.
